(19) United States
(12) Patent Application Publication
(10) Pub. No.: US 2020/0277924 A1
(43) Pub. Date: Sep. 3, 2020

(54) MULTIPLE-CHOICE PIGGYBACK IGNITION BOOSTER CIRCUIT FOR INTERNAL COMBUSTION ENGINES AND OTHER MOTORS

(71) Applicant: Fenton Horton, JR., Glen Burnie, MD (US)

(72) Inventor: Fenton Horton, JR., Glen Burnie, MD (US)

(21) Appl. No.: 16/288,537

(22) Filed: Feb. 28, 2019

(51) Int. Cl. F02P 3/04; F02P 15/12

(52) U.S. Cl. CPC F02P 3/0435; F02P 15/12

(57) ABSTRACT

A booster circuit for use with an ignition system for an internal combustion engine is provided. The booster circuit includes a relay control circuitry disposed in parallel between the voltage source and the one or more ignition coils for igniting fuel in the engine in synchronism with engine operation; a controllable switching element for selectively completing a booster circuit for connecting the relay control circuitry in series with the voltage source and the one or more ignition coils; and the booster circuit having electronic circuitry including at least one output for providing booster energy at the at least one output, when the booster circuit is completed by the controllable switching element to assure producing of a suitable voltage applied to the one or more ignition coils.

### BACKGROUND OF THE INVENTION

The present invention relates to ignition circuits for internal combustion engines and, more particularly, to a multi-choice piggyback ignition booster circuit for motors.

Booster circuits for ignition systems are required to provide additional power for better performance; for instance, to compensate for unsatisfactory performance of the ignition system during starting. Current booster circuits, however, also have the following drawbacks: they are electronically complex, they are bulky in size, they do not have a built-in backup or default bypass system, and they have limited vehicular compatibility—i.e., they do not fit on all vehicles, for example, possibly working on foreign but not domestic vehicles.

As can be seen, there is a need for a multiple-choice piggyback ignition booster that has near universal vehicular compatibility—compatible with foreign and domestic, old and new vehicles—that incorporates a built-in bypass or default system, wherein the operator has the option to turn it on and off. The multiple-choice piggyback ignition booster embodied in the present invention provides additional power for better performance in terms of torque and efficiency, on demand. The device can perform as an addition to the stock ignition system or through a manually operable on/off switch, so that the multiple-choice piggyback ignition booster embodied is smaller than current solutions and is capable of being used on any gasoline powered motor.

### BRIEF DESCRIPTION OF THE DRAWINGS

FIG. 1 is a schematic view of an exemplary embodiment of a relay control circuitry 10 of the present invention;

FIG. 2 is a schematic view of an exemplary embodiment of a (SPDT) switching element 40 of the present invention;

FIG. 3 is a schematic view of an exemplary embodiment of an inertia performance three-wire circuit with no switch of the present invention;

FIG. 4 is a schematic view of an exemplary embodiment of the inertia performance low power on/off circuit of the present invention, through adding a relay to FIG. 3 makes the device or unit an “on/off by-pass circuit”. The relay needs to be installed at the end of the circuit for the by-pass to work;

FIG. 5 is a schematic view of an exemplary embodiment of the inertia performance race on/off circuit configured to achieve greater performance through the device must have two diodes in the circuit of the present invention;

FIG. 6 is a schematic view of an exemplary embodiment of a bypass connection and relay is basically the same as FIG. 5 but showing the working of the internal relay of the present invention; and

FIG. 7 is a schematic view of an exemplary embodiment of an LED indicator 70 of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, the present invention may include a booster circuit for use with an ignition system for an internal combustion engine is provided. The booster circuit includes a relay control circuitry disposed in parallel between the voltage source and the one or more ignition coils for igniting fuel in the engine in synchronism with engine operation; a controllable switching element for selectively completing a booster circuit for connecting the relay control circuitry in series with the voltage source and the one or more ignition coils; and the booster circuit having electronic circuitry including at least one output for providing booster energy at the at least one output, when the booster circuit is completed by the controllable switching element to assure producing of a suitable voltage applied to the one or more ignition coils.

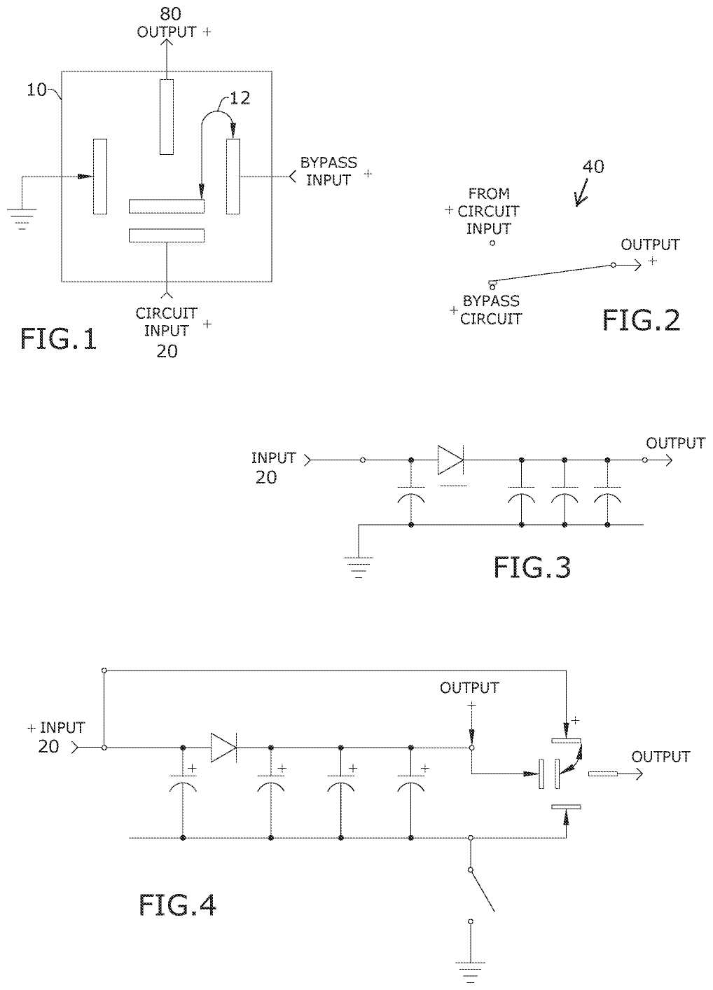

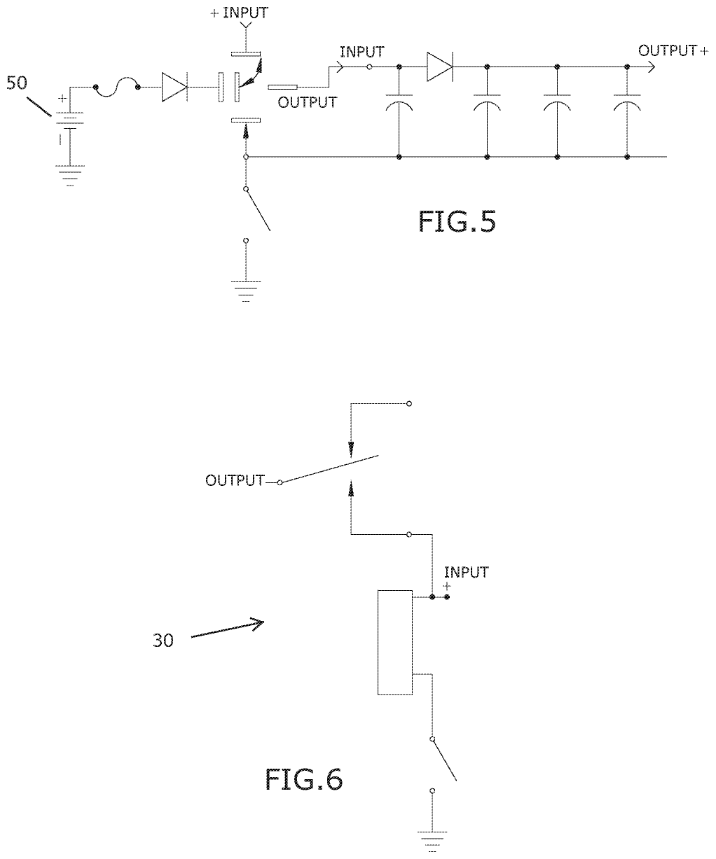

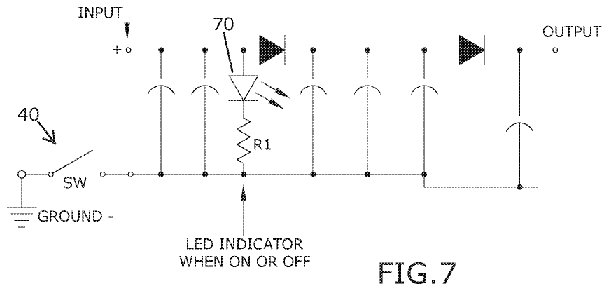

Referring to FIGS. 1 through 7, the present invention may include a relay control circuitry 10 selectively coupling an input circuitry 20 and a bypass circuitry 30 with output. The relay control circuitry 10 may include capacitors, diodes, transistors, resistors along with one or more switching elements 40 as indicated on the schematics.

The battery 50 may be connected to the fuse by an electrical connection, such as a 14-gauge wire. Vehicular voltage may be applied by the battery 50 through the fuse (provided by the input circuitry 20) to a first capacitor coupled to a diode connecting to a set of second capacitors connected to the normally open side of the relay control circuitry 10. The normally closed side of the relay control circuitry 10, which requires no power may be connected via the original power to the ignition coils (provided by the output circuitry 80). A single line from the relay control circuitry 10 may be connected to the ignition coils. The relay control circuitry 10 may be powered by the original source to the ignition coils. The switching element 40 may be an on/off switch that is put in series with the relay control circuitry 10 and the normal power source to the ignition along the same wire of the negative side of the relay control circuitry 10 providing ground.

A method of manufacturing the present invention may include the following. A manufacturer may utilize PC board to attach the electronic components including the diode to the positive side of the first capacitor. That line may then be connected to the normally open side of the relay control circuitry 10, while the positive wire coming from the fuse to the diode, wherein the opposite side of the diode is now connected to the capacitors, and wherein the line from the capacitors is now connected to the normally open side of the relay control circuitry 10. The original power wire for the ignition coils is now connected to the normally closed side of the relay control circuitry 10. The positive side of the relays coil may be connected to a switch element 40 in series to the original power source to the coil. The negative side of the capacitors may be connected in series to the resistor. The resistor may be connected to ground. The negative side of the relay coil may be connected to ground. The output from the relay is now connected to the ignition coils.

To use the present invention, a user would install the present invention disclosed above to a gasoline powered vehicle and hook it up to the coils (output circuitry 80) and battery 50. Currently this device should only be used in conjunction with the ignition system. Additionally, the device does have future potential applications for example “fuel injectors”.

It should be understood, of course, that the foregoing relates to exemplary embodiments of the invention and that modifications may be made without departing from the spirit and scope of the invention as set forth in the following claims.

What is claimed is:

1. A booster circuit for use with an ignition system for an internal combustion engine, the ignition system including a voltage source and one or more ignition coils, comprising:
a relay control circuitry disposed in parallel between the voltage source and the one or more ignition coils for igniting fuel in the engine in synchronism with engine operation;
a controllable switching element for selectively completing a booster circuit for connecting the relay control circuitry in series with the voltage source and the one or more ignition coils;
the booster circuit having electronic circuitry including at least one output for providing booster energy at the at least one output, when the booster circuit is completed by the controllable switching element to assure producing of a suitable voltage applied to the one or more ignition coils; and
said electronic circuitry including a second diode in parallel with the set of second capacitors connected to an open side of the relay control circuitry, configured to provide an on/off circuit.

2. The booster circuitry of claim 1, further comprising a first capacitor coupled to a first diode connecting upstream to the set of second capacitors.

3. The booster circuitry of claim 1, further comprising an LED indicator.
